(19) United States
(12) Patent Application Publication
(10) Pub. No.: US 2014/0048590 A1
(43) Pub. Date: Feb. 20, 2014

(54) Game With Barcodes

(71) Applicant: Ian Britt, West Covina, CA (US)

(72) Inventor: Ian Britt, West Covina, CA (US)

(21) Appl. No.: 13/587,579

(22) Filed: Aug. 16, 2012

(51) Int. Cl. G06F 17/00; G06K 19/06

(52) U.S. Cl. 235/375; 235/492; 235/494; 235/487

(57) ABSTRACT

Game items that enable a user to conduct an online transaction related to a purchasable product are presented. Game items can comprise a game component having an indicia related to a purchasable product, and a link key. The link key can be a barcode, QR code, radio frequency identifier, or other symbol encoded with data that enables an electronic device to conduct an online transaction.

### FIELD OF THE INVENTION

The field of the invention is game components with link keys.

### BACKGROUND

The following background discussion includes information that may be useful in understanding the present invention. It is not an admission that any of the information provided herein is prior art or relevant to the presently claimed invention, or that any publication specifically or implicitly referenced is prior art.

Various games, especially card games and board games, have been played by most individuals since their childhood. Games have been played for various purposes, including for example, leisure, learning, bonding, and competition. However, many games, especially board games and card games, have failed to fully engage players with the online digital world.

An example of a die that attempts to solve this problem is the Codigo Cube™. The Codigo Cube™ allows users to roll a physical dice, scan a QR code, and view and answer a multiple choice question via a smartphone (www.codigocube.com).

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

U.S. Pat. No. 8,206,217 to Witchey teaches physical objects having an interface that communicates with a virtual game world.

What the Codigo Cube™ and Witchey fail to appreciate is that game players can engage in an online transaction that directly relates to a purchasable product associated with indicia on a game component that could possibly make reference to the purchasable product.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for a game item and system that allows players to engage in an online purchase transaction that relates directly to a game component.

### SUMMARY OF THE INVENTIVE SUBJECT MATTER

The inventive subject matter provides apparatus, systems and methods in which an aspect of a physical game item enables a user to initiate a transaction related to a purchasable product.

In one aspect of the inventive subject matter, the game item can comprise a game component, a link key (e.g., barcode, QR code, etc.), and an indicia (e.g. alphanumeric text, image, etc.) related to a product. The link key can be encoded with data that allows a user to conduct a transaction with respect to the product via an electronic device, such as a mobile phone, a PDA, a tablet computer, or any other suitable device. It is contemplated that the link key and the indicia could be located on a single component or multiple components of the game item.

Each game component could comprise a card, a board, a die, a token, a box, a rule sheet, a 3-dimensional figure, a portion thereof, or any other suitable item that can be used in connection with a game.

As used herein, the term “indicia” is used broadly to refer to, for example, any alphanumeric text, an image, a sound, or even a gesture that is human understandable. In some embodiments, the indicia can be indicative of a purchasable product.

The term “link key” is also used broadly to refer to any machine readable symbol, for example, a bar code, a QR code, a radio frequency identifier, or any other suitable symbol.

As used herein, the term “product” is used broadly to refer to anything produced by labor or effort, including for example, goods or services.

Various types of transactions could be enabled, initiated or conducted in connection with the game item. It is contemplated that a user can stream digital media, or order, download or purchase a product related to an indicia on the game item. Such indicia can be representative movies, books, games, sports, music, or any other suitable product or activity. Example of indicia representative of music includes, for example, a song, an artist, an image of an album cover, an image of an artist, a hint related to a song or an artist, or a lyric.

It is contemplated that the transaction could be enabled by a server that is configured to acquire data, such as a digital representation, related to at least one of a link key and indicia. This server can be housed within or exterior to the electronic device. Where the server is housed exterior to the electronic device, it is contemplated that the server can be distal to the electronic device. Where a server is distal to the electronic device, it is contemplated that the electronic device can communicate with the server through a network, a cloud, a game service, or any other suitable medium.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a game item.

FIG. 2 is a schematic of a game card transaction system.

### DETAILED DESCRIPTION

It should be noted that while the following description is drawn to a computer/server based transaction system, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including production of game components that enable an electronic device to conduct an online transaction related to a purchasable product.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

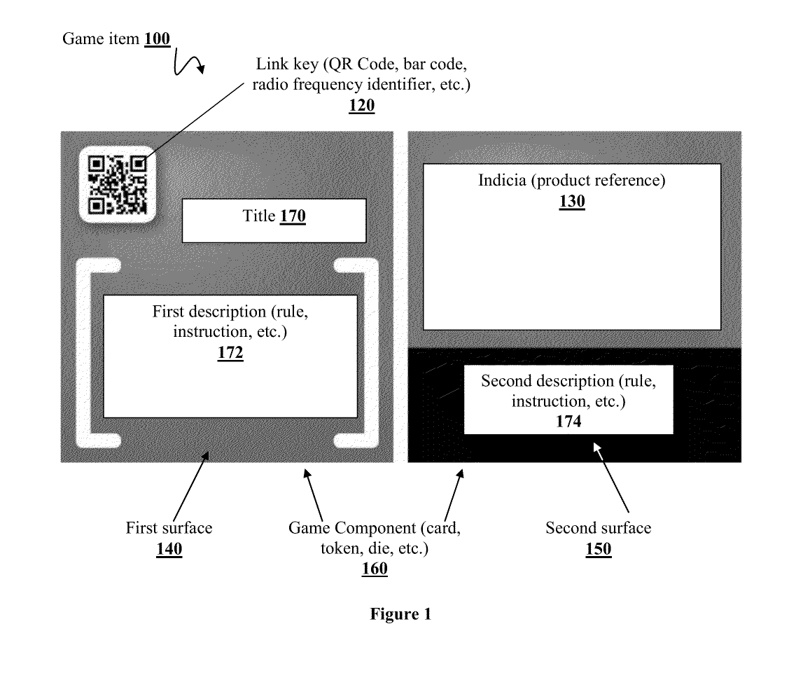

In FIG. 1, a game item 100 is shown. Game item 100 comprises a game component 160 having a first surface 140 and a second surface 150. First surface 140 comprises a link key 120, a title 170, and a first description 172. Second surface comprises an indicia 130 and second descriptions 174.

Game items and components for various types of games are contemplated, including for example, trivia games, learning games, collectable games, board games, card games, video games, die games, charade games, drawing games, any combination thereof, or any other suitable types of games.

Each game item could comprise a single game component, or comprise 2, 5, 10, or even 100 or more game components. A game component generally comprises a single object, but can comprise two or more separate objects that are to be used together for purposes of the game. An example of a two-object-game-component is the combination of (1) a poker chip having an indicia, and (2) a card having a QR code related to the indicia on the poker chip. Examples of one-piece-game-components include, for example, a game card, a die, a token, a board, or any other suitable game item. Each game component can comprise 1, 2, 4, 6, or even 8 or more surfaces. An example of a game component having six surfaces is a die. Although a game card is a 3D object it substantially has two effective surfaces.

It is contemplated that a game component could comprise multiple elements, such as the title 170, first description 172, second description 174, link key 120, and indicia 130 of game component 160. Alternatively, a game component could comprise one, two, three, or four of the above mentioned elements. Still further, a game component could comprise additional elements not shown in FIG. 1 (e.g., rules, graphics, textures, etc.).

Each of the elements (e.g., title, indicia, description, etc.) can be located on any surface of a game component, on any portion thereof. For example, link key 120 could have alternatively be located on a bottom portion of a second surface 150, while second description 174 could have been located on an upper left portion of a first surface 140.

In one more preferred aspect of the inventive subject matter, a game component related to a music trivia game can be provided. A game can include a plurality of game components where each component can comprise, among other things, a QR code and an indicia of purchasable music (e.g., digital music, compact discs, records, chord books, band merchandise, music books, tapes, music videos, live concert recordings, etc.). One or more players can use the QR code to link directly to a server that enables a user to conduct an online transaction related to the purchasable product. For example, a game card could comprise a picture of an artist and a QR code. This QR code can include a computer readable URL that enables a user device to connect to a web site or iTunes™ and purchase one or more songs sung by the artist in the picture. It is contemplated that the user could be presented with a single purchasable product or a plurality of purchasable products. It is further contemplated that the enabled transaction could comprise an order for a purchasable product, a streaming of a sample of digital media, a download of a purchasable product, or any other suitable transaction.

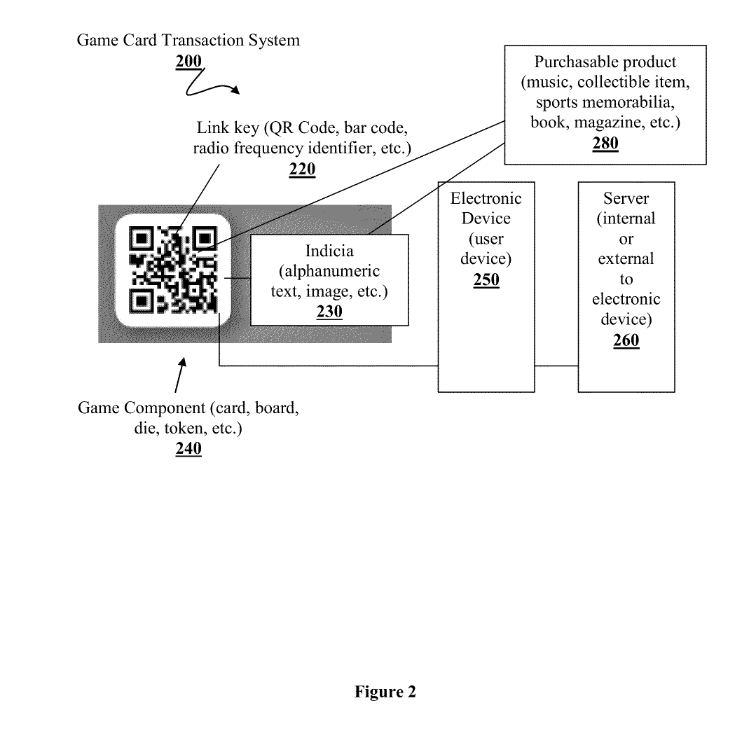

In FIG. 2, a game card transaction system 200 is shown. The system 200 comprises at least (1) a game component 240 having a link key 220, and an indicia 230 (e.g., an alphanumeric text, an image, etc.) related to the link key 220 and a purchasable product 280, and (2) a server configured to enable a transaction related to the link key 220. It is contemplated that a user could acquire a digital representation of the link key 220 through a user device 250, and use this digital representation to link to the server 260 via the user device 250.

As discussed above, the term “indicia” is used broadly to refer to, for example, any alphanumeric text, an image, a sound, or even a gesture. For example, indicia for a baseball trivia game can comprise, for example, a picture of a baseball player or team, or quoted words, a nickname, or stats of a baseball player or coach. Indicia can be directly related to a purchasable product, including for example, a trading card, a signed bat, a magazine featuring the baseball player or coach, a ticket to a baseball game, or any other relevant purchasable product.

The term “description” can also refer to any alphanumeric text, an image, a sound, or other description located on the game component. The description can refer to for example, a rule, an instruction, a hint, or a fact. For example a first description for the baseball trivia game described above can be a rule statement that states “move 4 spaces in any direction if correct; go back to starting position if incorrect,” and a second description be a fun fact about a baseball player, such as “Mike Piazza was born in 1968”.

In some embodiments the link key can also link to other aspects of the game component, possibly including rules to the game. For example, a game card can include a link key (e.g., a QR code) that points to a URL that resolves to a game rule server. During game play, a user can capture and decode the link key via their smart phone, which then obtains a current rule from the game server. Such approaches are considered advantageous for construction of dynamic games that change with time. One example use could target collectible trading card games such as Magic The Gathering® provided by Hasbro®.

A limited set of examples of titles, indicia and descriptions related to a music trivia game are shown in the Appendix of this application. It is contemplated that the titles, indicia and descriptions can vary greatly depending on the type or theme of the game.

It is contemplated that link keys or elements presented as code (e.g., bar code, QR code, etc.) can be dynamic in the sense where the content referenced by the link key can change with time. Thus, each link key or code could be regenerated at intervals, so that the elements of a game component a user played at one time could be replaced with a new set of elements or portion thereof. In this way, the game would never truly be the same at two given times, even when using the same physical game components in the same exact order with the same people. For example, a game card for a basketball trivia game could comprise (1) a link key pointing to a question, and (2) indicia associated with a topic of the question. The link key could be encoded with data that directs a user device (e.g., a mobile phone, a laptop computer, etc.) to the a game server with a “question of the day” related to the topic as well as a product that can be purchased associated with the question.

It is further contemplated that a user can customize a game component based on dynamic link keys and codes. Thus, a user or owner of the game can log on to the game server and could change the content to which a game's link keys point. When a game player activates one of the game's link keys, they will receive the customized content.

The dynamic link keys and codes described above could give rise to tailored advertising capabilities. A user can register their game via a registration username, password, cell phone number, IP address, or other identification information. Based on the registration information, user information, or a link key or code scanned or otherwise received by a user device, the user could be directed to a specific web page, online marketplace, or advertisement, discount or promotion tailored specifically to their game play experience. Such an approach gives rise to allowing a game publisher to print multiple copies of a single game component and configure a link key on the component to direct users to different web pages, online marketplaces, or advertisements, discounts or promotions based on their preferences.

In some aspects of the inventive subject matter, an expansion kit for a game can be provided. As used herein, the term “expansion kit” is used broadly to include any set of game components that can be used in connection with an existing game. For example, once someone has purchased a game (e.g., a music trivia game), he would not have to purchase an additional game in order to get new game components (e.g., game cards having trivia questions, link keys and indicia). Instead, he could simply purchase an expansion kit comprising additional game cards with new trivia questions, link keys and indicia. It is further contemplated that an expansion kit to a music trivia game could comprise game cards having trivia questions, link keys, and indicia related to a completely different theme. Thus, the purchaser of a music trivia game could purchase an expansion kit related to soccer, and use the expansion kit in connection with the music trivia game.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A physical game item, comprising:
a game component comprising at least one surface and an indicia related to a purchasable product;
a machine readable link key disposed on the surface; and
wherein the link key is encoded with data that enables an electronic device to conduct an online transaction with respect to the purchasable product.

2. The game item of claim 1, wherein the game component is at least one of a card, a board, a die, a token, a box, a rule sheet, and a 3-dimensional figure.

3. The game item of claim 1, wherein the indicia is at least one of an alphanumeric text and an image.

4. The game item of claim 1, wherein the link key is at least one of a barcode, a QR code, and a radio frequency identifier.

8. The game item of claim 1, wherein the transaction comprises a streaming of a sample of digital media.

9. The game item of claim 1, wherein the transaction comprises an order of the purchasable product.

10. The game item of claim 1, wherein the transaction comprises at least one of a purchase or a download.

11. The game item of claim 1, wherein the indicia is related to music.

12. The game item of claim 11, wherein the music is at least one of a song, an artist, and a lyric.

13. A game card transaction system for use in connection with a user device, comprising:
a game card comprising a link key and at least one of an alphanumeric text and an image related to the link key; and
a server configured to enable a transaction related to the link key via an acquiring of a digital representation of at least a portion of the link key from the user device.

14. The system of claim 13, wherein the link key comprises at least one of a barcode, a QR code, and a radio frequency identifier.

15. The system of claim 13, wherein the transaction is at least one of a purchase, a download, and an order related to the link key.

16. The system of claim 13, wherein the at least one of an alphanumeric text and an image is related to music.

17. The system of claim 16, wherein the music is at least one of a song, an artist, and a lyric.

18. The system of claim 13, wherein the server is external to the user device.

19. The system of claim 18, wherein the server is distal to the user device.

20. The system of claim 13, wherein the link key is machine readable.
